(19) United States
(12) Patent Application Publication
(10) Pub. No.: US 2002/0032657 A1
(43) Pub. Date: Mar. 14, 2002

(54) Credit card duplication prevention system and method

(76) Inventor: Kunwar C. Singh, Beverly Hills, CA (US)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/756,681

(22) Filed: Jan. 10, 2001

Related U.S. Application Data
(60) Provisional application No. 60/174,923, filed on Jan. 10, 2000.

(51) Int. Cl. G06F 17/60

(52) U.S. Cl. 705/44

(57) ABSTRACT

A retail payment device such as a smart credit card includes a substrate, with a processor disposed on the substrate. An activatable/deactivatable communication unit is connected to the processor, and an activation unit, a code generator, and a deactivation unit are also connected to the processor. The communication unit is configured to be disabled until an authorized activation action is provided by the activation unit, which actuates the processor to activate the communication unit.

### CROSS REFERENCE TO RELATED APPLICATIONS:

This application claims priority from U.S. provisional application Ser. No. 60/174,923, filed Jan. 10, 2000. The contents of this application is hereby incorporated by reference.

### BACKGROUND OF THE INVENTION:

1. Field of the Invention

A fast growing method of committing credit card fraud utilizes the duplication of the magnetic strip information of credit cards by a commercially available device referred to as an “duplicator”. A duplicator is capable of reading all of the credit card details from the magnetic strip on the back or front of a credit card, then programming these details onto a blank card. Such improper duplication can sometimes be performed by an unscrupulous retailer who, in the process of performing an apparent sales transaction, receives a credit card from a customer, swipes the credit card into the appropriate card reader for authorization purposes, then inappropriately swipes the card into a duplicator, outside of the view of the card holder. The duplicator can be hidden behind a store counter or teller's desk. After the card holder leaves the premisses, it is possible for a blank card to be duplicated, and improperly and illegally used until such time as the credit card information is deactivated by the credit card company. Typically, card holders are not aware of this type of duplication and credit card fraud until a monthly statement is received with unauthorized charges thereupon. This can be as much as one month or even longer after the theft or duplication of the card occurs.

2. Description of the Related Art

Currently, the only way to prevent the duplication of credit cards or unauthorized charges is careful observance by the card holder of the handling of their card by retailers, and careful monitoring of their accounts by either the careful examination of written statements and/or electronic monitoring via internet access. However, since there is a significant amount of delay in the posting of credit card charges, this is not a reliable way to prevent fraud by duplication in this method. Additionally, in the event of loss or theft of cards, the unavoidable time lag before reporting and cancellation/deactivation provides a significant window of unauthorized use. Such unauthorized or fraudulent use creates a significant expense for credit card holders, as well as credit card companies. The present invention is directed to reducing or eliminating the unauthorized use of credit cards.

### SUMMARY OF THE INVENTION

The invention therefore comprises a retail payment device such as a smart credit card or comparable device, comprising a substrate, with a processor disposed on the substrate. An activatable/deactivatable communication unit is connected to the processor, and an activation unit is also connected to the processor. A code generator is connected to the processor, as is a deactivation unit. The communication unit is configured to be disabled until an authorized activation action is provided by the activation unit, which actuates the processor to activate the communication unit.

### BRIEF DESCRIPTION OF THE DRAWINGS

For a clear description of examples of the present invention, reference should be made to the following drawings, wherein:

FIG. 1 illustrates a rear view of a credit card according to an example of the present invention;

FIG. 2 illustrates a block diagram of functional aspects of a credit card or charge medium according to the present invention; and

FIG. 3 illustrates, in more detail, an embodiment of the present invention.

### DETAILED DESCRIPTION OF THE PREFERRED EMBODIMENTS

The present invention, therefore, utilizes a special credit card which must be specifically activated by the card holder each time the card is to be used. The card is activated so as to be swiped only once, and then automatically deactivated. If a retailer therefore sought to swipe the card into a duplicator after swiping the card through an appropriate card reader, the card would be deactivated and the magnetic information would therefore be unreadable. If the retailer asked the card holder to duplicate the card for a second time, the card holder would be alerted as to the fact that a potential problem could be in the process of being created.

The invention, therefore, is directed to embodiments of a credit card or a charge medium wherein automatic withdrawal of funds or purchase authorization is essentially eliminated. Dispensing or charging of funds from the account of a card holder will require both the credit card and input from the account holder; without specified authorized input from the account holder, the credit card will not provide the necessary authorization which will be needed for each and every use of the card. As will be discussed below, each swipe of the card in a normal credit card transaction would read and then deactivate the card, thereby making it impossible to use again until it is reactivated. As will be discussed below, a credit card or charge medium according to the invention includes an integrated circuit which utilizes a processor and code generator, and the necessary components in order to enable the card holder to activate the credit card. The card holder would only be able to initiate or accomplish the activation process through the use of a number of personal input methods. As will be discussed below, a touch pad/key pad, fingerprint reader, or other device.

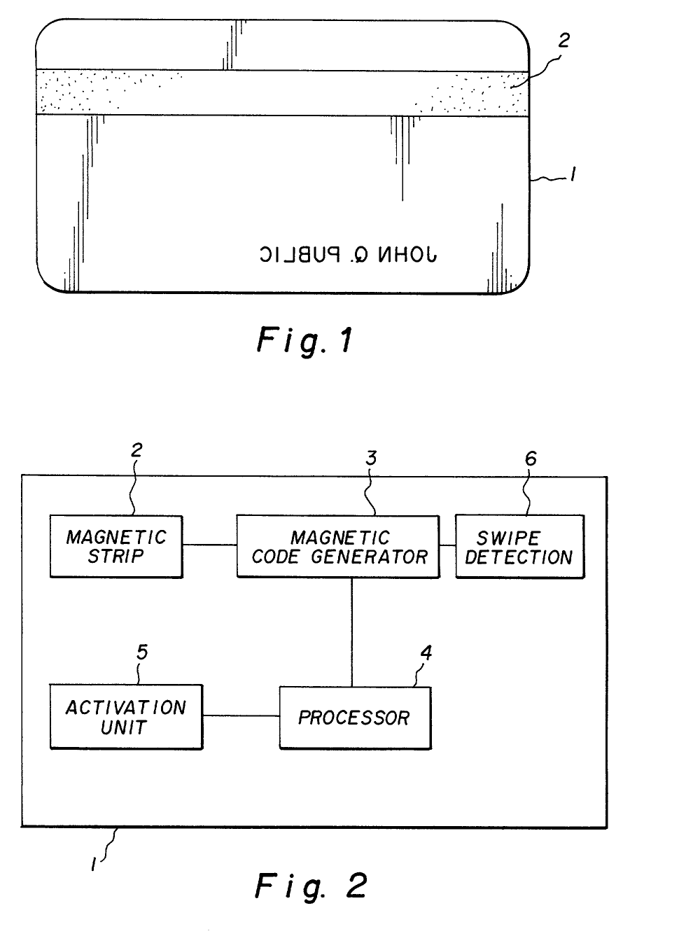

Referring to FIG. 1, a rear view is provided of credit card 1 having magnetic strip 2 thereupon. In its normal or deactivated mode, magnetic strip 2 may have magnetic code containing all of the pertinent credit card information thereupon; however, in the normal or deactivated mode, this magnetic information would be masked by magnetic noise, or otherwise rendered unreadable by a magnetic strip reader. FIG. 2 illustrates a schematic diagram of the functional features of credit card 1. Magnetic strip 2, containing the magnetic code, is connected to a magnetic code generator 3, which generates magnetic signals based upon output from processor 4. Processor 4 can be configured to instruct a magnetic code generator to either generate magnetic noise to make magnetic strip 2 unreadable until activated, or, in an alternative embodiment, can be instructed to generate the appropriate magnetic signal information to magnetic strip 2 so that the card can be read after activation. Additionally, as will be discussed below, magnetic code generator 3 can work in conjunction with processor 4 and magnetic strip 2, as long as, after activation, magnetic strip 2 is readable. Activation unit 5 is connected to processor 4, and provides a signal to processor 4 to instruct the magnetic code generator 3 to activate magnetic strip 2, or otherwise make magnetic strip 2 readable. A swipe detection unit 6 is connected to magnetic code generator 3 and/or magnetic strip 2. After a single swipe through a card reader, swipe detection unit 6 sends a signal to the magnetic code generator 3 in order to deactivate magnetic strip 2.

Activation unit 5 can be a number of manually activated devices. For example, activation unit 5 could include a keypad disposed on the surface of the credit card, and configured so that the keypad responds to a predetermined code which is entered by the card holder. In the alternative, the activation unit 5 could comprise a fingerprint reader, or another activation system which can only be activated by a designated card holder.

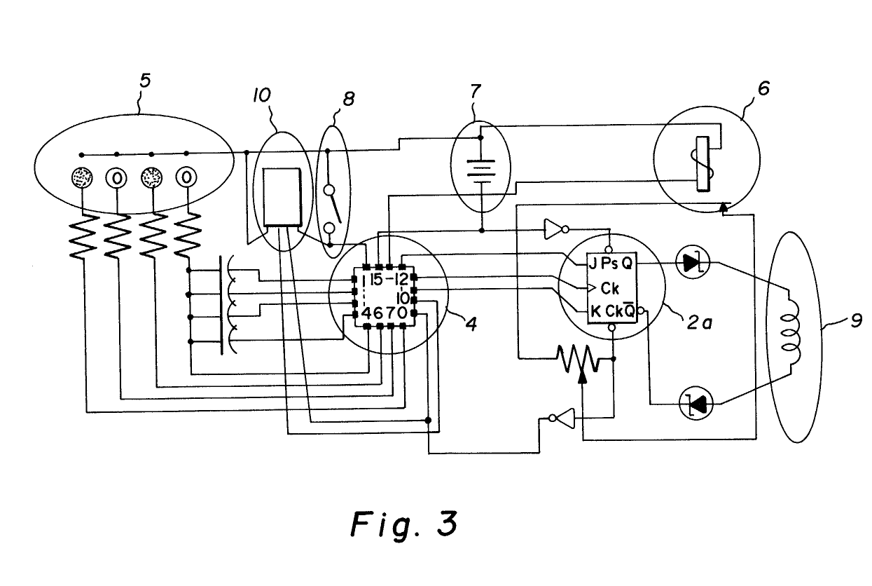

FIG. 3 illustrates, in more detail, the elements of a credit card according to the invention. Integrated circuit 4, swipe detector 6, activation unit 5, and other elements of the invention are supplemented, as illustrated, with a power supply 7 to supply appropriate power to the components, and, in another embodiment, could include a timed shut off switch 8. Timed shut off switch 8 can be configured to automatically deactivate the card after a predetermined time, whether or not the card has been swiped through the credit card reader. It should be noted that FIG. 3 also illustrates, in conjunction with swipe detection mechanism 6, a deactivator mechanism 9 which functions to deactivate magnetic strip 2 as illustrated in FIG. 2a, or deactivation unit 2a as illustrated in FIG. 3. As shown in FIG. 3, the alternative embodiment of the deactivator unit 2a includes logic circuitry. Also shown in the embodiment of FIG. 3 is an indicator unit 10 which can be provided to indicate whether or not the card is in an activated state or a deactivated state. This indicator unit can be in the form of an LCD or LED unit, or any other low-voltage low-current indicator which can effectively indicate an activated or an inactivated state.

It should be noted that, in FIG. 3, activation unit 5 is illustrated as being a four digit touch pad. Any number of comparable activation touch pads, fingerprint readers, or other devices could be used. Applicants also note that detection unit 6 and deactivator mechanisms are shown as inductive coils; however, other configurations are also within the spirit and scope of the invention.

Magnetic code generator 3, processor 4, activation unit 5, and swipe detection unit 6 and the other elements noted above can be formed of discrete circuit components which are sufficiently small to be implemented on a regular credit card, with an appropriate power source, without significant increasing the thickness of the card or otherwise making the card unusable. In the alternative, all of these elements can be configured on a single substrate, such as a silicon chip, with an appropriate touch pad or thumb print recognition unit connected to the activation circuitry. Swipe detection unit 6 can consist of a mechanical swipe detector, a magnetic detector which detects when the card enters a magnetic field for reading, or other suitable circuitry or mechanism to ensure that only a single swipe occurs with each activation.

In addition to preventing unauthorized swiping or duplication of the card, this type of activation technology will prevent the card from being used for purchases if the card is stolen, since the card will be in its deactivated state.

The above-discussed embodiments of the invention are illustrative only, and are not intended to be limiting in any way. In order to determine the proper spirit and scope of the invention, reference should be made to the appended claims.

1. A retail payment device, comprising:
a substrate;
a processor disposed on said substrate;
an activatable/deactivatable communication unit connected to said processor;
an activation unit connected to said processor;
a code generator connected to said processor; and
a deactivation unit connected to said processor;
wherein said communication unit is configured to be disabled until an authorized activation action is provided by said activation unit, which actuates said processor to activate the communication unit.

2. A retail payment device as recited in claim 1, wherein said deactivation unit deactivates the communication unit after a single transmission of data therefrom.

3. A retail payment device as recited in claim 1, wherein said communication unit is a magnetic strip.

4. A retail payment device as recited in claim 1, wherein said activation unit comprises a touch pad.

5. A retail payment device as recited in claim 1, wherein said activation unit comprises a fingerprint reader.

6. A retail payment device as recited in claim 1, wherein said substrate, processor, communication unit, activation unit, code generator, and deactivation unit comprise a smart credit card.

7. A retail payment device as recited in claim 1, wherein said code generator comprises a magnetic code generator which generates authorized credit card account information upon activation by said activation unit.

8. A retail payment device as recited in claim 1, wherein said deactivation unit comprises a swipe detection unit which is configured to deactivate the communication unit after a single swipe of the substrate through a credit card reader.

9. A retail payment device as recited in claim 1, further comprising a power supply unit to supply power to said processor.

10. A retail payment device as recited in claim 1, further comprising a display connected to said processor, said display indicating whether the communication unit is in an active or deactive state.

11. A retail payment device as recited in claim 1, wherein, in a deactivated state, said communication unit is an inactive magnetic strip.

12. A retail payment device as recited in claim 1, wherein, in a deactivated state, said communication unit is a magnetic strip containing sufficient magnetic noise so as to render the strip unreadable by a magnetic strip reader.

13. A retail payment device as recited in claim 1, wherein said authorized activation action is initiated by entrance of a predetermined code onto the activation unit.

14. A retail payment device as recited in claim 1, wherein said authorized activation action is the scanning of a fingerprint on a fingerprint reading device which is also disposed on the substrate and connected to the processor.

15. A retail payment device as recited in claim 1, wherein said communication unit comprises a magnetic strip, said activation unit comprises a touch pad, and wherein upon entrance of a predetermined code onto said touch pad, said code generator generates authorized code information which is transmitted to said magnetic strip, thereby effectively activating the retail payment device for use as a credit card.

16. A retail payment device as recited in claim 15, wherein said deactivation unit deactivates the magnetic strip after a single swipe of the magnetic strip through a magnetic strip reader.
